(19) United States
(12) Patent Application Publication
(10) Pub. No.: US 2026/0170246 A1
(43) Pub. Date: Jun. 18, 2026

(54) METHOD AND DEVICE WITH AUGMENTED TOKEN REPRESENTATION FOR OBTAINING RESULT TOKEN

(71) Applicant: Samsung Electronics Co., Ltd., Suwon-si (KR)

(72) Inventors: Jiho CHOI, Suwon-si (KR); Sangil JUNG, Suwon-si (KR)

(73) Assignee: Samsung Electronics Co., Ltd., Suwon-si (KR)

(21) Appl. No.: 19/223,443

(22) Filed: May 30, 2025

(30) Foreign Application Priority Data
Dec. 17, 2024 (KR) 10-2024-0189003

(51) Int. Cl. G06F 40/284; G06F 40/40; G06V 10/774

(52) U.S. Cl. CPC G06F 40/284; G06F 40/40; G06V 10/774

(57) ABSTRACT

An electronic device includes: a processor; and a memory including one or more storage media storing instructions configured cause the electronic device to: receive an input data set including input image data and input text data; obtain an image embedding vector corresponding to the input image data using an image encoder; obtain a first text token set corresponding to the input text data using a text tokenizer; obtain a first text embedding vector set corresponding to the first text token set using a text encoder; and obtain a first result token corresponding to the image embedding vector and the first text embedding vector set using a decoder; wherein a target text embedding vector selected, based on the image embedding vector, from among candidate text embedding vectors for a target text token in the first text token set, is added to the first text embedding vector set.

### CROSS-REFERENCE TO RELATED APPLICATIONS

This application claims the benefit under 35 USC § 119(a) of Korean Patent Application No. 10-2024-0189003, filed on December 17, 2024, in the Korean Intellectual Property Office, the entire disclosure of which is incorporated herein by reference for all purposes.

### BACKGROUND

### 1. Field

The following description relates to a technology for processing data in an artificial intelligence model, and more particularly, to a technology for determining an embedding vector corresponding to a text token and obtaining a result token representing output data by a multi-modal foundation model (MMFM).

### 2. Description of Related Art

A multi-modal foundation model (MMFM) may receive inputs of various modalities. A modality is a type of input data. Unlike artificial intelligence models that receive only a single type of data, an MMFM may be trained using data in which modalities are fused together. An MMFM trained using fused data may be used when there are various types of input data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: one or more processors; and a memory including one or more storage media storing instructions configured cause the electronic device to: receive an input data set including input image data and input text data; obtain an image embedding vector corresponding to the input image data using an image encoder; obtain a first text token set corresponding to the input text data using a text tokenizer; obtain a first text embedding vector set corresponding to the first text token set using a text encoder; and obtain a first result token corresponding to the image embedding vector and the first text embedding vector set using a decoder; wherein a target text embedding vector selected, based on the image embedding vector, from among candidate text embedding vectors for a target text token in the first text token set, is added to the first text embedding vector set.

The instructions may be further configured to cause the electronic device to, based on determining that the text token set includes the target text token: determine a first similarity between the image embedding vector and a first candidate text embedding vector of the candidate text embedding vectors; determine a second similarity between the image embedding vector and a second candidate text embedding vector of the plurality of candidate text embedding vectors; and select between the first candidate text embedding vector and the second candidate text embedding vector to serve as the target text embedding vector corresponding to the target text token based on the first similarity and the second similarity.

The instructions may be further configured to cause the electronic device to: obtain, using the text encoder, a second text embedding vector set corresponding to a second text token set, the second text token set including at least a portion of the first text token set and including the first result token; and obtain, using the decoder, a second result token corresponding to the image embedding vector and the second text embedding vector set.

The instructions may be further configured to cause the electronic device to: obtain a text embedding vector set corresponding to a text token set and repeatedly obtain a result token by using the decoder until it is determined that a preset special token is obtained as the result token.

A first candidate text embedding vector, among the candidate text embedding vectors, may be included in a first dataset for a first domain, and a second candidate text embedding vector, among the candidate text embedding vectors, may be included in a second dataset for a second domain.

The instructions may be further configured to cause the electronic device to: obtain output data corresponding to the input data set based on the first result token.

The output data may be obtained using a multi-modal large language model (MMLLM) that includes the encoder, the decoder, and the image encoder.

The instructions may be further configured to cause the electronic device to: generate a first input embedding space based on the image embedding vector and the first text embedding vector set; and obtain the first result token by inputting the first input embedding space to the decoder.

In another general aspect, a method of obtaining a result token is performed by a computing device, and the method includes: receiving an input data set including input image data and input text data; obtaining an image embedding vector corresponding to the input image data using an image encoder; obtaining a first text token set corresponding to the input text data using a text tokenizer; obtaining a first text embedding vector set corresponding to the first text token set using a text encoder; and obtaining a first result token corresponding to the image embedding vector and the first text embedding vector set using a decoder; wherein a target text embedding vector selected, based on the image embedding vector, from among candidate text embedding vectors for a target text token in the first text token set, is included in the first text embedding vector set.

The obtaining of the first text embedding vector set corresponding to the first text token set may include, based on determining that the text token set includes the target text token: determining a first similarity between the image embedding vector and a first candidate text embedding vector among the candidate text embedding vectors; determining a second similarity between the image embedding vector and a second candidate text embedding vector among the candidate text embedding vectors; and selecting between the first candidate text embedding vector and the second candidate text embedding vector to serve as the target text embedding vector corresponding to the target text token based on the first similarity and the second similarity.

The method may further include: obtaining, using the text encoder, a second text embedding vector set corresponding to a second text token set, the second token set including at least a portion of the first text token set and including the first result token; and obtaining, using the decoder, a second result token corresponding to the image embedding vector and the second text embedding vector set.

Obtaining a text embedding vector set corresponding to a text token set and obtaining the result token using the decoder may be repeatedly performed until a preset special token is obtained as the result token.

A first candidate text embedding vector, among the candidate text embedding vectors, may be included in a first dataset for a first domain, and a second candidate text embedding vector, among the candidate text embedding vectors, may be included in a second dataset for a second domain.

The method may further include: obtaining output data corresponding to the input data set based on the first result token.

The output data may be obtained using a multi-modal large language model (MMLLM).

The obtaining of the first result token using the decoder may include: generating a first input embedding space based on the image embedding vector and the first text embedding vector set; and obtaining the first result token by inputting the first input embedding space to the decoder.

In another general aspect, an electronic device includes: one or more processors; and a memory including one or more storage media storing instructions configured to cause the electronic device to: receive a training input data set including training input image data and training input text data; obtain a training image embedding vector corresponding to the training input image data by applying an image encoder to the training input image data; obtain a first training text token set, including first training text tokens corresponding to at least a portion of the training input text data, by a text tokenizer to the training input text data; obtain a first training text embedding vector set, including text embedding vectors respectively corresponding to the first training text tokens, by applying a text encoder to the first training text token set; and update the image encoder, the text tokenizer, the text encoder, and/or a decoder based on the training input data set, the training image embedding vector, and the first training text embedding vector set; wherein, based on determining that the first training text token set includes a target text token, a target text embedding vector is added to the first training text embedding vector set, wherein the target text embedding vector is selected from among candidate text embedding vectors for the target text token, and wherein the selecting is based on a domain determined for the training input data set.

The target text embedding vector may be selected based on an association thereof with the domain.

The instructions may be further configured to cause the electronic device to, in response to the first training text token set including the target text token: determine a domain corresponding to the training input data set based on the training image embedding vector; and select, based on the domain, between a first candidate text embedding vector and a second candidate text embedding vector, to serve as the target text embedding vector.

A first candidate text embedding vector among the candidate text embedding vectors may be included in a first database for a first domain, and a second candidate text embedding vector among the candidate text embedding vectors may be included in a second database for a second domain.

Other features and aspects will be apparent from the following detailed description, the drawings, and the claims.

### BRIEF DESCRIPTION OF THE DRAWINGS

FIG. 1 illustrates an example of an electronic device, according to one or more embodiments.

FIG. 2 illustrates an example of a method of obtaining a result token, according to one or more embodiments.

FIG. 3 illustrates an example of operations for obtaining a result token, according to one or more embodiments.

FIG. 4 illustrates an example of a method of determining a target text embedding vector, according to one or more embodiments.

FIG. 5 illustrates an example of operations for obtaining a text embedding vector set, according to one or more embodiments.

FIG. 6 illustrates an example of a method of obtaining a result token based on an input embedding space, according to one or more embodiments.

FIG. 7 illustrates an example of a method of obtaining a second result token based on a first result token, according to one or more embodiments.

FIG. 8 illustrates an example of operations for obtaining a second result token based on a first result token, according to one or more embodiments.

FIG. 9 illustrates an example of a method of obtaining output data corresponding to input data, according to one or more embodiments.

FIG. 10 illustrates an example of a training apparatus, according to one or more embodiments.

FIG. 11 illustrates an example of a method of training a model that generates a result token, according to one or more embodiments.

FIG. 12 illustrates an example of a method of determining a target text embedding vector based on a domain for a training input data set, according to one or more embodiments.

FIG. 13 illustrates an example of a method of training a text encoder based on a training result token, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles "a," "an," and "the" are intended to include the plural forms as well, unless the context clearly indicates otherwise. As used herein, the term "and/or" includes any one and any combination of any two or more of the associated listed items. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being "connected to," "coupled to," or "joined to" another component or element, it may be directly "connected to," "coupled to," or "joined to" the other component or element, or there may reasonably be one or more other components or elements intervening therebetween. When a component or element is described as being "directly connected to," "directly coupled to," or "directly joined to" another component or element, there can be no other elements intervening therebetween. Likewise, expressions, for example, "between" and "immediately between" and "adjacent to" and "immediately adjacent to" may also be construed as described in the foregoing.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term "may" herein with respect to an example or embodiment, e.g., as to what an example or embodiment may include or implement, means that at least one example or embodiment exists where such a feature is included or implemented, while all examples are not limited thereto.

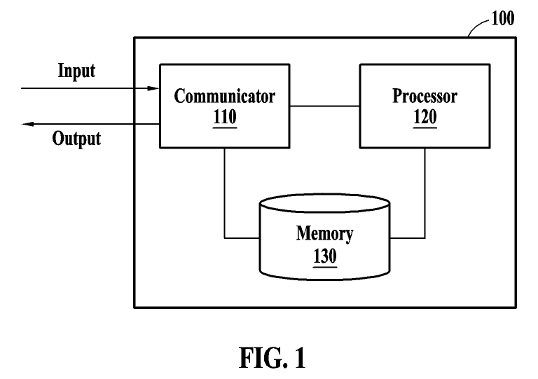

FIG. 1 illustrates an example of an electronic device, according to one or more embodiments.

An electronic device 100 may include a communicator 110, a processor 120, and a memory 130.

The communicator 110 may be connected to the processor 120 and the memory 130 and transmit and receive data to and from the processor 120 and the memory 130. The communicator 110 may be connected to another external device and transmit and receive data to and from the external device. Hereinafter, transmitting and receiving "A" may refer to transmitting and receiving "information or data indicating A."

The communicator 110 may be implemented as circuitry in the electronic device 100. For example, the communicator 110 may include an internal bus and/or an external bus. In another example, the communicator 110 may be an element that connects the electronic device 100 to the external device. The communicator 110 may be an interface (e.g., a network interface card). The communicator 110 may receive data from the external device and transmit the data to the processor 120 and the memory 130.

The processor 120 processes the data received by the communicator 110 and data stored in the memory 130. The "processor" may be a data processing device implemented by hardware including a circuit having a physical structure to perform desired operations. The desired operations may include, for example, code or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 120 may execute computer-readable code (e.g., software) stored in a memory (e.g., the memory 130) and instructions triggered by the processor 120. For example, a method of obtaining a result token by the electronic device 100 may be performed through the execution of instructions.

The memory 130 may store the data received by the communicator 110 and the data processed by the processor 120. For example, the memory 130 may store a program (or an application, or software). The stored program may be a set of syntaxes that are coded and executable by the processor 120 to provide the method of obtaining a result token.

The memory 130 may include, for example, at least one volatile memory, non-volatile memory, random-access memory (RAM), flash memory, a hard disk drive, and an optical disc drive.

The memory 130 may store an instruction set (e.g., software) for operating the electronic device 100. The instruction set for operating the electronic device 100 is executed by the processor 120.

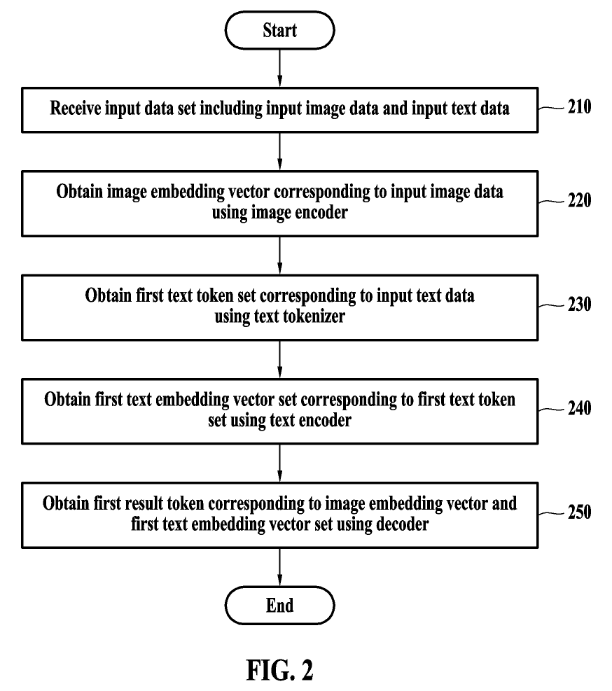

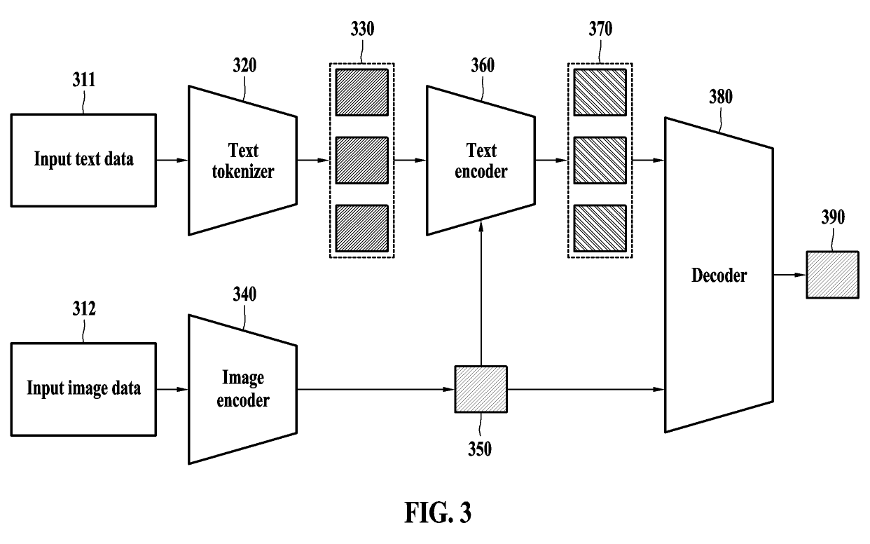

FIG. 2 illustrates an example of a method of obtaining a result token according to one or more embodiments, and FIG. 3 illustrates an example of operations for obtaining a result token according to one or more embodiments.

Operations 210 to 250 may be performed by an electronic device (e.g., the electronic device 100 of FIG. 1). For example, the electronic device may include a communicator (e.g., the communicator 110 of FIG. 1), a processor (e.g., the processor 120 of FIG. 1), and a memory (e.g., the memory 130 of FIG. 1). The electronic device includes a communication device such as a smartphone, a vehicle such as a car, a display device such as a television (TV), a consumer electronic apparatus such as a washing machine, a manufacturing apparatus, and the like.

According to an example, referring to FIG. 3, the electronic device may generate a result token (e.g., a first result token 390) based on a multi-modal input data set (e.g., an input text data 311 and an input image data 312), and generate output data based on the result token. For example, the electronic device may include a multi-modal foundation model (MMFM) capable of receiving and processing various modalities, such as the input image data 312 or the input text data 311. For example, the electronic device may use an image encoder 340, a text tokenizer 320, a text encoder 360, and a decoder 380 which are included in the MMFM to generate a result token. The image encoder 340, the text tokenizer 320, the text encoder 360, and the decoder 380 are not limited to separate hardware modules and may be implemented as software/instruction modules that perform corresponding operations. The MMFM may include other components, for example, other networks or sub-networks, components to transform/normalize input data or intermediate data, and the like. That is to say, the components depicted in FIG. 3 may be incorporated into any MMFM.

In operation 210, the electronic device may receive an input data set including the input image data 312 and the input text data 311.

The electronic device may obtain output data corresponding to the input data set using a multi-modal large language model (MMLM). The MMLM may generate texts as the output data for the received various modalities of input data. The MMLM may, for example, receive an image and a text including a question about the image, and generate a text that corresponds to the image and a response to the question.

According to an example, the input text data 311 may include text data obtained from audio input data (e.g., a voice of a user) and/or text input data (e.g., text input data of a user).

According to an example, the input image data 312 may include image data obtained from input image data (e.g., at least one image inputted/specified by a user) or generated image data (e.g., an image captured by a camera connected to the electronic device).

In operation 220, the electronic device may obtain an image embedding vector 350 corresponding to the input image data 312 using the image encoder 340. The image embedding vector 350 may represent features of the input image data 312 as a vector in an embedding space so that information about the image data may be input to the decoder 380.

For example, the image encoder 340 may extract image features for at least a portion of the input image data 312, generate an image token set of image tokens respectively corresponding to the image features, and determine the image embedding vector 350 corresponding to (and based on) the image token set. For example, image features may be extracted from the input image data through image preprocessing and a process of extracting a feature of an image. The image preprocessing of the image data may include a process of adjusting the input image data and a process of normalizing the data (e.g., pixel values). The process of extracting the features of the image may include a process of performing a convolution product using a kernel and a pooling process. For example, image feature embedding vectors respectively corresponding to image features may be generated, and an image embedding vector 350 may be generated based on the image feature embedding vectors. For example, the image embedding vector 350 may be express the corresponding image features in a cross-modality embedding space in which both an embedding vector representing an image and an embedding vector representing a text may be expressed.

In operation 230, the electronic device may obtain a first text token set 330 corresponding to the input text data 311 using the text tokenizer 320. For example, the text tokenizer 320 may generate the first text token set 330 by tokenizing the input text data 311 into tokens. For example, the tokens of the input text data 311 may represent various lexical units, such as word units, sub-word units, or character units.

In operation 240, the electronic device may obtain a first text embedding vector set 370 corresponding to the first text token set 330 using the text encoder 360. A text embedding vector may represent a text token as a vector so that information about a text may be input to the decoder 380. For example, text embedding vectors included in the first text embedding vector set 370 may express the corresponding lexical units in a cross-modality embedding space in which both an embedding vector representing an image and an embedding vector representing a text may be expressed.

For example, the text encoder 360 may generate the first text embedding vector set 370 by transforming the text tokens included in the input text token set into respectively corresponding text embedding vectors. The first text embedding vector set 370 may include text embedding vectors respectively corresponding to the tokens included in the first text token set 330.

For example, the text encoder 360 may store one embedding vector for one text token. When one text token corresponds to one embedding vector, a token with multiple meanings (depending on domains thereof) may be represented by the same embedding vector, and thus, a response different from a context presented by a question may be presented. The domains of a single text token may each be a different situation or a context shown by a different meaning of the single text token. For example, the word "chip" may have a domain in which it means snacks and the word "chip" also have a domain in which it means a semiconductor device. These meanings/domains are not distinguished and are input to the decoder as the same embedding vector, and a response regarding snacks may be generated for a question about a semiconductor device.

For example, the text encoder 360 may store multiple candidate text embedding vectors for a given single text token, and may use these candidate text embedding vectors to transform the given single text token into one of the candidate text embedding vectors. The candidate text embedding vectors may represent different meanings depending on the domains. For example, a first candidate text embedding vector may be a text embedding vector representing a domain-neutral (or generic) chip when the context of the text is not specified. For example, when the context of the text is specific to a semiconductor field/domain, a second candidate text embedding vector may be a text embedding vector representing a semiconductor chip. When text tokens corresponding to the candidate text embedding vectors are input, the text encoder 360 may determine/select one of the candidate text embedding vectors to be the text embedding vector for one of the text tokens by determining a domain corresponding to the input data set and by determining/selecting the one of the candidate text embedding vectors accordingly. To summarize, the electronic device may determine a domain corresponding to a context of a text token (where the text token may represent different meanings), and may transform the text token into a text embedding vector corresponding to the domain, so that the text embedding vector of the text token reflects the domain when it is input to the decoder 380; in this way, a more accurate result token and output data may be obtained.

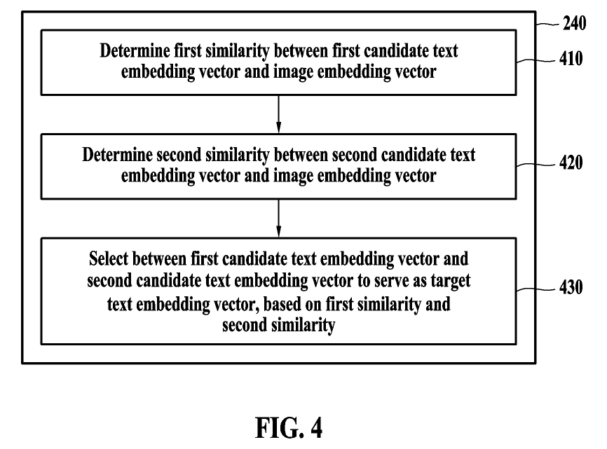

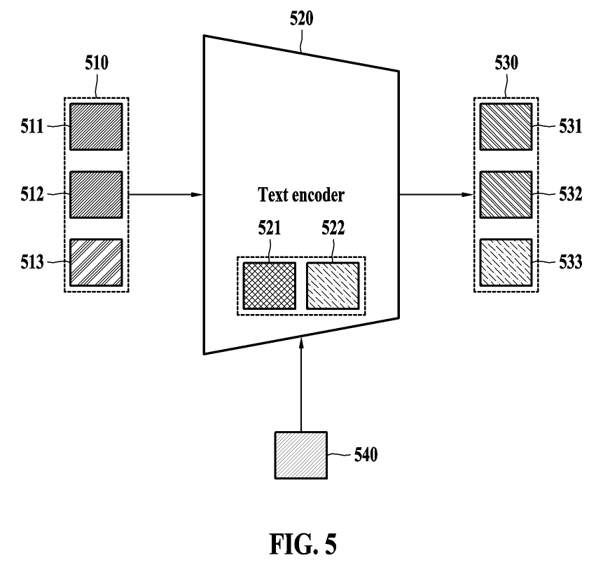

According to an example, when a target text token set (e.g., text token set 330) includes a target text token (e.g., one of the text tokens in text token set 330), a target text embedding vector for the target text token may be determined/selected, for inclusion in the text embedding vector set (e.g., the first text embedding vector set 370), from among corresponding candidate text embedding vectors, and the determining/selecting may be based on the image embedding vector 350. A method of determining the target text embedding vector corresponding to the target text token by the text encoder 360 is described with reference to FIGS. 4 and 5.

In operation 250, the electronic device may obtain the first result token 390 corresponding to the image embedding vector 350 and the first text embedding vector set 370 using the decoder 380. For example, the decoder 380 may calculate predicted probability distributions for respective tokens based on the input image embedding vector 350 and the text embedding vector set, and determine a result token based on the calculated probability distributions.

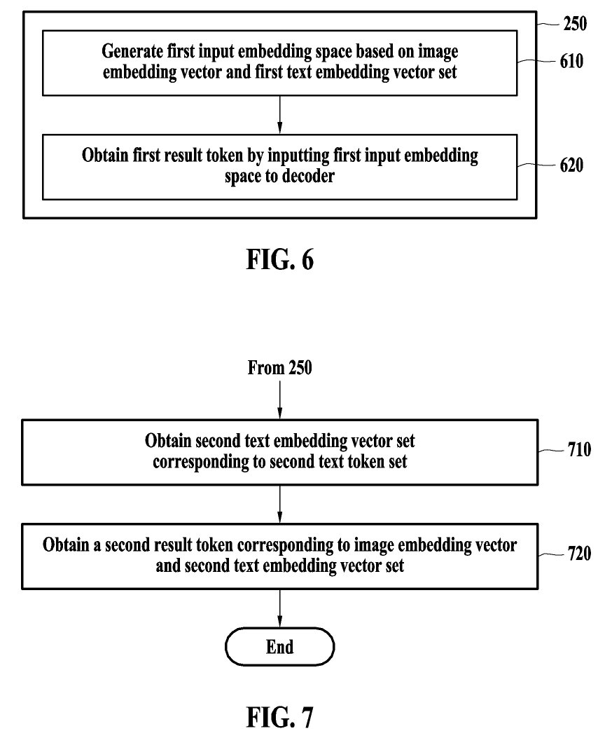

The electronic device may generate a first input embedding space based on the image embedding vector 350 and the first text embedding vector set 370, and generate the first result token 390 by inputting the first input embedding space to the decoder 380. When an embedding space in which an embedding vector representing an image and an embedding vector representing a text are concatenated is generated, a relationship between the input image data 312 and the input text data 311 may be reflected in the generation of the output data. The method of generating the first input embedding space is described with reference to FIG. 6.

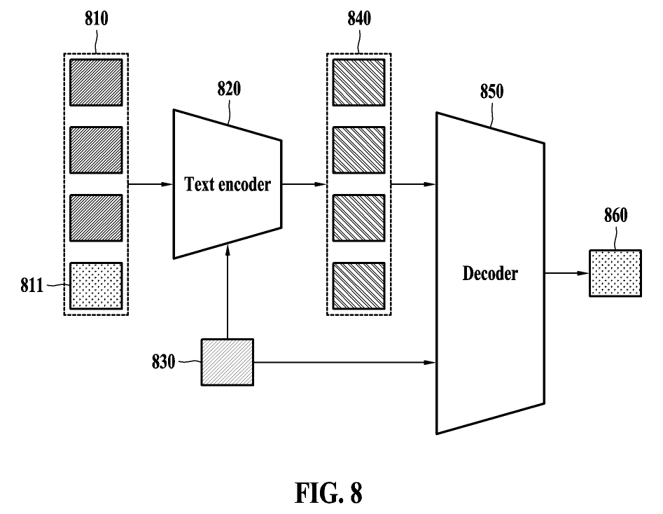

The electronic device may generate result tokens by repeating an operation of including the generated result token in a text token set and generating a new result token based on the image embedding vector 350 and a text embedding vector set corresponding to the text token set that includes the generated result token. The aforementioned operation of generating each of the result tokens may be repeated, for example, until a special token that terminates the generation of the output data is obtained as the final result token. The output data corresponding to the input data set may be obtained based on the result tokens. A method of obtaining the result tokens representing the output data is described with reference to FIGS. 7 and 8.

FIG. 4 illustrates an example of a method of determining a target text embedding vector according to one or more embodiments, and FIG. 5 illustrates an example of operations for obtaining a text embedding vector set according to one or more embodiments.

Operations 410 to 430 may be performed by an electronic device (e.g., the electronic device 100 of FIG. 1). The electronic device may include a communicator (e.g., the communicator 110 of FIG. 1), a processor (e.g., the processor 120 of FIG. 1), and a memory (e.g., the memory 130 of FIG. 1). For example, operation 240 described above with reference to FIG. 2 may include operations 410 to 430.

According to an example, a text encoder 520 (e.g., the text encoder 360 of FIG. 3) may generate a text embedding vector set 530 (e.g., the first text embedding vector set 380 of FIG. 3) including text embedding vectors 531 to 533 respectively corresponding to text tokens 511 to 513 included in a text token set 510 (e.g., the first text token set 330 of FIG. 3). For example, a first text token 511 may be transformed into a first text embedding vector 531 and included in the text embedding vector set 530, and a second text token 512 may be transformed into a second text embedding vector 532 and included in the text embedding vector set 530.

According to an example, as shown in FIG. 5, when the text token set 510 is determined to include a target text token 513 (described later), the text encoder 520 may include one of candidate text embedding vectors 521 and 522 for the target text token 513 as a target text embedding vector 533 into the text embedding vector set 530. For example, the text encoder 520 may determine/select the target text embedding vector 533 based on an image embedding vector 540 (e.g., the image embedding vector 350 of FIG. 3). The candidate text embedding vectors 521 and 522 may represent respective different meanings depending on the domains.

According to an example, the electronic device may determine/select the target text embedding vector 533 based on similarities between the image embedding vector 540 and the candidate text embedding vectors 521 and 522, respectively.

In operation 410, the electronic device may determine a first similarity, which is a similarity between the first candidate text embedding vector 521 and the image embedding vector 540. For example, the first candidate text embedding vector 521 may be included in a first database (or dictionary, etc.) for a first domain. For example, the first domain may be a domain that represents a situation in which the context in which the target text token 513 is used is not specified (e.g., a generic domain, a non-specified domain, etc.). For example, the electronic device may determine the first similarity by calculating a cosine similarity between the first candidate text embedding vector 521 and the image embedding vector 540. The method of determining the first similarity is not limited to the example described above, and various methods capable of calculating the similarity between vectors may be used to determine the first similarity.

In operation 420, the electronic device may determine a second similarity, which is a similarity between a second candidate text embedding vector 522 and the image embedding vector 540. For example, the second candidate text embedding vector 522 may be included in a second database (or dictionary) for a second domain. For example, the second domain may be a domain that represent a context in which the target text token 513 is used and is specific to a particular field (e.g., a question about a semiconductor device or a question about in-house data). The same method as the method used to determine the first similarity may be used to determine the second similarity.

In operation 430, the electronic device may determine/select the first candidate text embedding vector 521 or the second candidate text embedding vector 522 as the target text embedding vector 533 (for the target text token 513) based on the first similarity and the second similarity. For example, when the first similarity is higher than the second similarity, the first candidate text embedding vector 521 may be determined/selected as the target text embedding vector 533, and when the second similarity is higher than the first similarity, the second candidate text embedding vector 522 may be determined/selected as the target text embedding vector 533. That is, the most similar candidate text embedding vector may be selected.

According to an example, rather than select a most-similar text embedding vector, the electronic device may determine a domain for the input data set, and, based thereon, determine/select one of the candidate text embedding vectors 521 and 522 as the target text embedding vector 533. For example, when the domain for the input data set (e.g., the input text data 311 and the input image data 312 of FIG. 3) is determined as the first domain, the first candidate text embedding vector 521 may be determined/selected as the target text embedding vector 533 (based on its corresponding to the first domain, e.g., per a tag, associated field, or property of the vector indicating its domain). When the domain for the input data set is determined as the second domain, based thereon, the second candidate text embedding vector 522 may be determined as the target text embedding vector 533. For example, the electronic device may determine a domain for the input data set based on tags included in the input data set. For example, the electronic device may determine the domain for the input data set based on a result obtained by inputting the image embedding vector 540 into a domain classification model (e.g., a convolutional neural network (CNN) model). Rather than determining the domain may from the input data set, the domain may be determined based on extrinsic factor, for example a search context, a prior input data set, a global setting, etc. The method of determining the domain for the input data set is not limited to the described examples.

To summarize, the electronic device may determine a domain corresponding to a text token where the text token may represent different meanings, and may transform the text token into a text embedding vector corresponding to the domain, so that the text embedding vector reflecting the domain is inputted to the decoder, and a more accurate result token and output data may be obtained.

FIG. 6 illustrates an example of a method of obtaining a result token based on an input embedding space, according to one or more embodiments.

Operations 610 and 620 may be performed by an electronic device (e.g., the electronic device 100 of FIG. 1). The electronic device may include a communicator (e.g., the communicator 110 of FIG. 1), a processor (e.g., the processor 120 of FIG. 1), and a memory (e.g., the memory 130 of FIG. 1). For example, operation 250 described above with reference to FIG. 2 may include operations 610 and 620.

In operation 610, the electronic device may generate a first input embedding space based on both an image embedding vector (e.g., the image embedding vector 350 of FIG. 3 or the image embedding vector 540 of FIG. 5) and a first text embedding vector set (e.g., the first text embedding vector set 370 of FIG. 3 or the text embedding vector set 530). For example, a first input embedding space may be generated as values included in the image embedding vector and values included in the first text embedding vector are concatenated in various ways (i.e., different combinations of concatenations).

In operation 620, the electronic device may generate a first result token (e.g., the first result token 390 of FIG. 3) by inputting the first input embedding space to a decoder (e.g., the decoder 380 of FIG. 3). As the embedding space (in which the embedding vector representing the image and the embedding vector representing the text are concatenated) is input to the decoder, a relationship between input image data (e.g., the input image data 312 of FIG. 3) and input text data (e.g., the input text data 311 of FIG. 3) may be reflected in the generation of the output data.

FIG. 7 illustrates an example of a method of obtaining a second result token based on a first result token according to one or more embodiments, and FIG. 8 illustrates an example of operations for obtaining a second result token based on a first result token according to one or more embodiments.

Operations 710 and 720 may be performed by an electronic device (e.g., the electronic device 100 of FIG. 1). The electronic device may include a communicator (e.g., the communicator 110 of FIG. 1), a processor (e.g., the processor 120 of FIG. 1), and a memory (e.g., the memory 130 of FIG. 1). For example, operations 710 and 720 may be performed after operation 250 described above with reference to FIG. 2 is performed.

According to an example, referring to FIG. 8, the electronic device may generate result tokens by repeating an operation of including the generated result token (e.g., the first result token 390 of FIG. 3 or a first result token 811) in a text token set and generating a next result token based on an image embedding vector 830 (e.g., the image embedding vector 350 of FIG. 3 or the image embedding vector 540 of FIG. 5) and a text embedding vector set (e.g., a second text embedding vector set 840) corresponding to the next text token set (e.g., a second text token set 810) including the generated result token.

In operation 710, the electronic device may obtain the second text embedding vector set 840 corresponding to the second text token set 810 including at least a portion of a first text token set (e.g., the first text token set 330 of FIG. 3 or the text token set 510 of FIG. 5) and the first result token 811 (e.g., the first result token 390 of FIG. 3) using a text encoder 820 (e.g., the text encoder 360 of FIG. 3 or the text encoder 520 of FIG. 5).

In operation 720, the electronic device may obtain a second result token 860 corresponding to the image embedding vector 830 and the second text embedding vector set 840 using a decoder 850 (e.g., the decoder 380 of FIG. 3). The operation of generating a new result token (e.g., the operation of obtaining the text embedding vector set corresponding to the text token set and the operation of obtaining the new result token using the decoder) may be repeated until a special token that terminates the generation of the output data is obtained as the result token. The final output data corresponding to the input data set may be obtained based on the iteratively generated result tokens.

The description of the operations of obtaining the first result token 811 described with reference to FIGS. 2 to 6 may be similarly modified and applied to the operations of obtaining the second result token 860 or other subsequent result tokens.

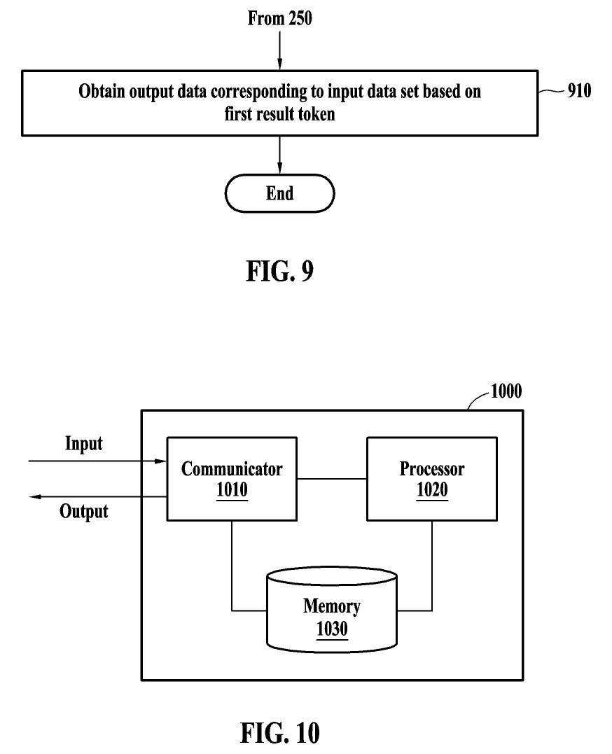

FIG. 9 illustrates an example of a method of obtaining output data corresponding to input data, according to one or more embodiments.

Operation 910 may be performed by an electronic device (e.g., the electronic device 100 of FIG. 1). The electronic device may include a communicator (e.g., the communicator 110 of FIG. 1), a processor (e.g., the processor 120 of FIG. 1), and a memory (e.g., the memory 130 of FIG. 1). For example, operation 910 may be performed after operation 250 described above with reference to FIG. 2 is performed.

In operation 910, the electronic device may obtain final output data corresponding to an input data set (e.g., the input text data 311 and the input image data 312) based on a first result token (e.g., the first result token 390 of FIG. 3 or the first result token 811). The electronic device may generate the output data based on result tokens iteratively obtained in response to the input data set. For example, the input image and response to a question may be generated as a text based on the generated result tokens.

FIG. 10 illustrates an example of a training apparatus, according to one or more embodiments.

According to an example, a training apparatus 1000 includes a communicator 1010, a processor 1020, and a memory 1030. The training apparatus 1000 may be an electronic device.

The descriptions of a communicator (e.g., the communicator 110 of FIG. 1), a processor (e.g., the processor 120 of FIG. 1), and a memory (e.g., the memory 130 of FIG. 1) included in an electronic device (e.g., the electronic device 100 of FIG. 1) that performs the method of obtaining the result token may be similarly modified and applied to the descriptions of the communicator 1010, the processor 1020, and the memory 1030 included in the training apparatus 1000, respectively.

The processor 1020 executes computer-readable code (e.g., software) stored in a memory (e.g., the memory 1030) and instructions triggered by the processor 1020. For example, a method of training an MMFM of the training apparatus 1000 through the execution of instructions may be performed.

The memory 1030 stores data received by the communicator 1010 and data processed by the processor 1020. For example, the memory 1030 may store a program (or an application, or software). The stored program may be a set of syntaxes that are coded and executable by the processor 1020 to provide the method of training an MMFM.

The memory 1030 may store an instruction set (e.g., software) for operating the training apparatus 1000. The instruction set for operating the training apparatus 1000 is executed by the processor 1020.

According to an example, the training apparatus 1000 may be the same electronic device that performs the method of obtaining a result token. For example, the training apparatus 1000 may obtain a result token and output data based on an input data set, and at the same time, train an MMFM to obtain the result token and the output data.

According to another example, the training apparatus 1000 may be a device other than the electronic device that performs the method of obtaining a result token. For example, the MMFM may be trained by the training apparatus 1000 to obtain the result token and the output data, and the MMFM may be replicated or transmitted to the electronic device that performs the method of obtaining a result token.

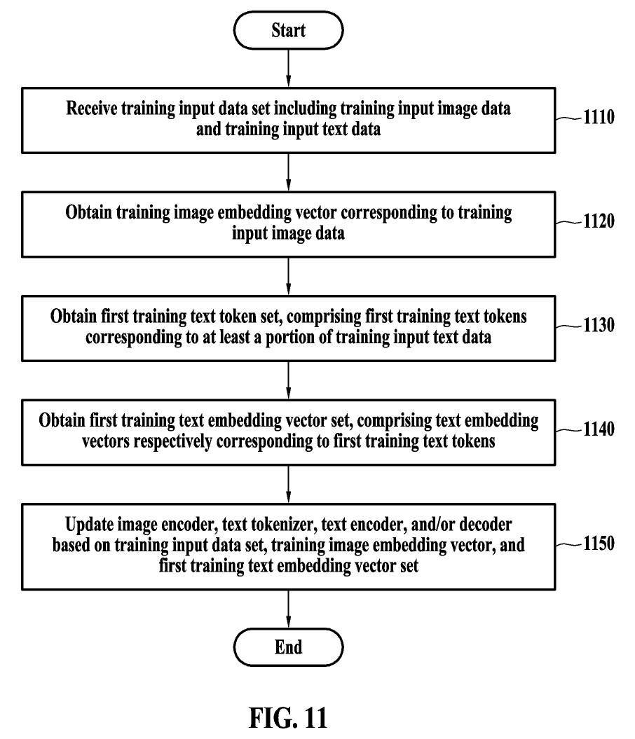

FIG. 11 illustrates an example of a method of training a model that generates a result token, according to one or more embodiments.

Operations 1110 to 1150 may be performed by an electronic device (e.g., the training apparatus 1000 of FIG. 10). The electronic device may include a communicator (e.g., the communicator 1010 of FIG. 10), a processor (e.g., the processor 1020 of FIG. 10), and a memory (e.g., the memory 1030 of FIG. 10).

According to an example, the MMFM included in the electronic device (e.g., the electronic device 100 of FIG. 1) that performs the method of obtaining the result token may be updated by the electronic device that performs the method of training the MMFM based on the training input data set. The electronic device may use an image encoder, a text tokenizer, a text encoder, and a decoder included in the MMFM to train the MMFM based on the training input data set.

In operation 1110, the electronic device may receive a training input data set including training input image data and training input text data.

In operation 1120, the electronic device may obtain training image embedding data corresponding to training input image data using the image encoder.

In operation 1130, the electronic device may obtain a first training text token set corresponding to at least a portion of the training input text data using the text tokenizer.

In operation 1140, the electronic device may obtain a first training text embedding vector set corresponding to the first training text token set using the text encoder.

The description of operations 210 to 240 described above with reference to FIG. 2 may be similarly modified and applied to the description of operations 1110 to 1140.

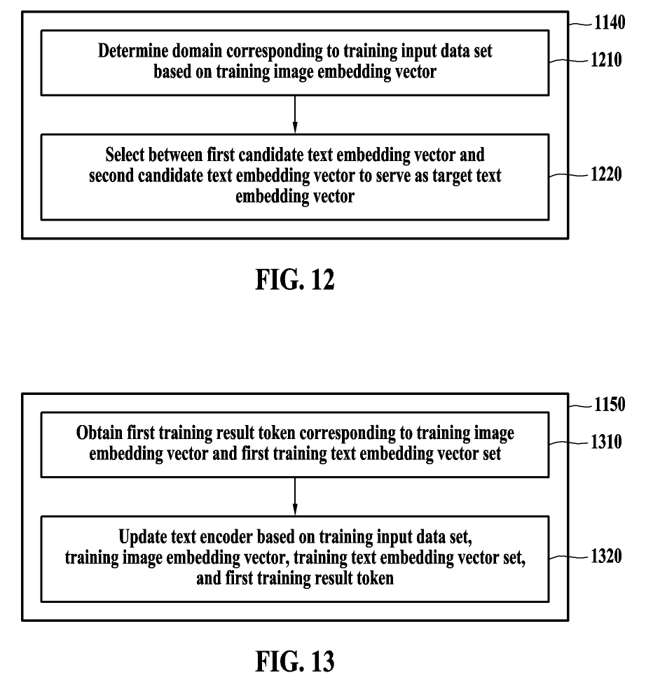

According to an example, when the first training text token set includes a target text token, a target text embedding vector determined based on a domain determined for training data among a plurality of candidate text embedding vectors for the target text token may be included in the text embedding vector set. A method of determining the target text embedding vector corresponding to the target text token by the text encoder will be described in detail below with reference to FIG. 12.

In operation 1150, the electronic device may update at least one of the image encoder, the text tokenizer, the text encoder, or the decoder based on the training input data set, the training image embedding vector, and the first training text embedding vector set. The updating may be an operation of training a machine learning model using a training data set, thereby training the model to produce an output that corresponds to a new input. The MMFM may be trained as the image encoder, the text tokenizer, the text encoder, and/or the decoder included in the MMFM is/are updated.

The electronic device may train the MMFM using, but is not limited to, supervised learning, unsupervised learning, self-supervised learning, or any combination thereof. The electronic device may additionally fine-tune the MMFM. The process of training the MMFM by the electronic device may include the following training processes: (1) data preparation; (2) model initialization; (3) forward calculation (4) loss calculation; (5) backpropagation; and (6) parameter update.

The data preparation process is the process in which the training apparatus collects and preprocesses a training input data set. The preprocessing process may include cleaning the training input data set and, if necessary, performing tasks such as standardization, normalization, and feature selection to prepare the training data to be suitable for use in the MMFM.

The model initialization process is the process of setting an initial parameter of the MMFM, which may include, for example, initializing a weight and a bias when the MMFM is a neural network. The forward calculation process is the process of inputting prepared training input data set to the MMFM and calculating an output value of the MMFM. The output value may include a training result token or output data corresponding to the training input data set.

The loss calculation process is the process of calculating a difference between an output value of the MMFM and an actual ground truth (label) using a loss function. A loss function is a function that calculates a value representing accuracy (or inaccuracy) of the output value of the MMFM.

The backpropagation process is the process of adjusting parameters of the MMFM to reduce a loss derived through the loss function (e.g., using gradient descent or a similar technique). By differentiating the value of the loss function through a backpropagation algorithm, a degree of the contribution of each parameter of the MMFM to the loss may be calculated, and the parameters of the MMFM may be updated based on the calculated value.

The parameter update process is the process of updating the parameters of the MMFM using a calculated gradient. Gradient descent or deformation thereof may normally be used for the parameter update. Through this process, the MMFM may be trained to output increasingly accurate output values. The above processes (the forward calculation, the loss calculation, the backpropagation, and the parameter update) may be repeated multiple times for a large number of training data, and the training may proceed multiple times until the MMFM is sufficiently trained.

FIG. 12 illustrates an example of a method of determining a target text embedding vector based on a domain for a training input data set, according to one or more embodiments.

Operations 1210 and 1220 may be performed by an electronic device (e.g., the training apparatus 1000 of FIG. 10). The electronic device may include a communicator (e.g., the communicator 1010 of FIG. 10), a processor (e.g., the processor 1020 of FIG. 10), and a memory (e.g., the memory 1030 of FIG. 10). For example, operation 1140 described above with reference to FIG. 11 may include operations 1210 and 1220.

According to an example, the text encoder may generate a training text embedding vector set including training text embedding vectors corresponding to the respective training text tokens included in the training text token set.

According to an example, when the training text token set includes a target text token, the text encoder may include one of candidate text embedding vectors for the target text token as a target text embedding vector in the training text embedding vector set. For example, the text encoder may determine the target text embedding vector based on the image embedding vector. Each of the candidate text embedding vectors may represent different meanings depending on domains.

According to an example, the electronic device may determine/select the target text embedding vector based on a domain determined for the training input data set.

In operation 1210, the electronic device may determine a domain corresponding to the training input data set based on the training image embedding vector. For example, the electronic device may determine the domain for the training input data set based on tags included in the training input data set. For example, the electronic device may determine the domain for the training input data set based on a result to be obtained by inputting the training image embedding vector into a domain classification model (e.g., a convolutional neural network model). A method of determining the domain for the training input data set is not limited to the described examples.

In operation 1220, the electronic device may determine/select a first candidate text embedding vector or a second candidate text embedding vector as the target text embedding vector corresponding to the target text token based on the domain. For example, the first candidate text embedding vector may be included in a first database (or dictionary) for a first domain, and the second candidate text embedding vector may be included in a second database (or dictionary) for a second domain. For example, when the domain for the training input data set is determined as the first domain, the first candidate text embedding vector may be determined as the target text embedding vector. For example, when the domain for the training input data set is determined as the second domain, the second candidate text embedding vector may be determined as the target text embedding vector.

According to an example, unlike as shown in FIG. 12, the electronic device may determine/select the target text embedding vector based on similarities between the image embedding vector and the candidate text embedding vectors. The description of the method of determining the target text embedding vector described above with reference to FIG. 4 may be similarly modified and applied to the description of the method of determining the target text embedding vector based on the similarity.

FIG. 13 illustrates an example of a method of training a text encoder based on a training result token, according to one or more embodiments.

Operations 1310 and 1320 may be performed by an electronic device (e.g., the training apparatus 1000 of FIG. 10). The electronic device may include a communicator (e.g., the communicator 1010 of FIG. 10), a processor (e.g., the processor 1020 of FIG. 10), and a memory (e.g., the memory 1030 of FIG. 10). For example, operation 1150 described above with reference to FIG. 11 may include operations 1310 and 1320.

In operation 1310, the electronic device may obtain a first training result token corresponding to the training embedding vector and the first training text embedding vector set using a decoder. For example, the decoder may calculate a predicted probability distribution for each of a plurality of tokens based on the input training image embedding vector and the training text embedding vector set, and determine a training result token based on the calculated probability distribution.

In operation 1320, the electronic device may update the text encoder based on the training input data set, the training image embedding vector, the training text embedding vector set, and the first training result token. For example, as the text encoder is updated, the values of the text embedding vectors or the candidate text embedding vectors stored corresponding to the respective text tokens may be adjusted so that the text embedding vector determined by the text encoder accurately represents the text token.

The computing apparatuses, the electronic devices, the processors, the memories, the displays, the information output system and hardware, the storage devices, and other apparatuses, devices, units, modules, and components described herein with respect to FIGS. 1-13 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-13 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
a memory comprising one or more storage media storing instructions configured cause the electronic device to:
receive an input data set comprising input image data and input text data;
obtain an image embedding vector corresponding to the input image data using an image encoder;
obtain a first text token set corresponding to the input text data using a text tokenizer;
obtain a first text embedding vector set corresponding to the first text token set using a text encoder; and
obtain a first result token corresponding to the image embedding vector and the first text embedding vector set using a decoder;
wherein a target text embedding vector selected, based on the image embedding vector, from among candidate text embedding vectors for a target text token in the first text token set, is added to the first text embedding vector set.

2. The electronic device of claim 1, wherein the instructions are further configured to cause the electronic device to, based on determining that the text token set includes the target text token:
determine a first similarity between the image embedding vector and a first candidate text embedding vector of the candidate text embedding vectors;
determine a second similarity between the image embedding vector and a second candidate text embedding vector of the plurality of candidate text embedding vectors; and
select between the first candidate text embedding vector and the second candidate text embedding vector to serve as the target text embedding vector corresponding to the target text token based on the first similarity and the second similarity.

3. The electronic device of claim 1, wherein the instructions are further configured to cause the electronic device to:
obtain, using the text encoder, a second text embedding vector set corresponding to a second text token set, the second text token set comprising at least a portion of the first text token set and comprising the first result token; and
obtain, using the decoder, a second result token corresponding to the image embedding vector and the second text embedding vector set.

4. The electronic device of claim 3, wherein the instructions are further configured to cause the electronic device to:
obtain a text embedding vector set corresponding to a text token set and repeatedly obtain a result token by using the decoder until it is determined that a preset special token is obtained as the result token.

5. The electronic device of claim 1, wherein
a first candidate text embedding vector, among the candidate text embedding vectors, is included in a first dataset for a first domain, and
a second candidate text embedding vector, among the candidate text embedding vectors, is included in a second dataset for a second domain.

6. The electronic device of claim 1, wherein the instructions are further configured to cause the electronic device to:
obtain output data corresponding to the input data set based on the first result token.

7. The electronic device of claim 6, wherein the output data is obtained using a multi-modal large language model (MMLLM) that includes the encoder, the decoder, and the image encoder.

8. The electronic device of claim 1, wherein the instructions are further configured to cause the electronic device to:
generate a first input embedding space based on the image embedding vector and the first text embedding vector set; and
obtain the first result token by inputting the first input embedding space to the decoder.

9. A method of obtaining a result token, the method performed by a computing device and comprising:
receiving an input data set comprising input image data and input text data;
obtaining an image embedding vector corresponding to the input image data using an image encoder;
obtaining a first text token set corresponding to the input text data using a text tokenizer;
obtaining a first text embedding vector set corresponding to the first text token set using a text encoder; and
obtaining a first result token corresponding to the image embedding vector and the first text embedding vector set using a decoder;
wherein a target text embedding vector selected, based on the image embedding vector, from among candidate text embedding vectors for a target text token in the first text token set, is included in the first text embedding vector set.

10. The method of claim 9, wherein the obtaining of the first text embedding vector set corresponding to the first text token set comprises, based on determining that the text token set includes the target text token:
determining a first similarity between the image embedding vector and a first candidate text embedding vector among the candidate text embedding vectors;
determining a second similarity between the image embedding vector and a second candidate text embedding vector among the candidate text embedding vectors; and
selecting between the first candidate text embedding vector and the second candidate text embedding vector to serve as the target text embedding vector corresponding to the target text token based on the first similarity and the second similarity.

11. The method of claim 9, further comprising:
obtaining, using the text encoder, a second text embedding vector set corresponding to a second text token set, the second token set comprising at least a portion of the first text token set and comprising the first result token; and
obtaining, using the decoder, a second result token corresponding to the image embedding vector and the second text embedding vector set.

12. The method of claim 11, wherein obtaining a text embedding vector set corresponding to a text token set and obtaining the result token using the decoder are repeatedly performed until a preset special token is obtained as the result token.

13. The method of claim 9, wherein
a first candidate text embedding vector, among the candidate text embedding vectors, is included in a first dataset for a first domain, and
a second candidate text embedding vector, among the candidate text embedding vectors, is included in a second dataset for a second domain.

14. The method of claim 9, further comprising:
obtaining output data corresponding to the input data set based on the first result token.

15. The method of claim 14, wherein the output data is obtained using a multi-modal large language model (MMLLM).

16. The method of claim 9, wherein the obtaining of the first result token using the decoder comprises:
generating a first input embedding space based on the image embedding vector and the first text embedding vector set; and
obtaining the first result token by inputting the first input embedding space to the decoder.

17. An electronic device comprising:
one or more processors; and
a memory comprising one or more storage media storing instructions configured to cause the electronic device to:
receive a training input data set comprising training input image data and training input text data;
obtain a training image embedding vector corresponding to the training input image data by applying an image encoder to the training input image data;
obtain a first training text token set, comprising first training text tokens corresponding to at least a portion of the training input text data, by a text tokenizer to the training input text data;
obtain a first training text embedding vector set, comprising text embedding vectors respectively corresponding to the first training text tokens, by applying a text encoder to the first training text token set; and
update the image encoder, the text tokenizer, the text encoder, and/or a decoder based on the training input data set, the training image embedding vector, and the first training text embedding vector set;
wherein, based on determining that the first training text token set includes a target text token, a target text embedding vector is added to the first training text embedding vector set, wherein the target text embedding vector is selected from among candidate text embedding vectors for the target text token, and wherein the selecting is based on a domain determined for the training input data set.

18. The electronic device of claim 17, wherein the target text embedding vector is selected based on an association thereof with the domain.

19. The electronic device of claim 17, wherein the instructions are further configured to cause the electronic device to, in response to the first training text token set comprising the target text token:
determine a domain corresponding to the training input data set based on the training image embedding vector; and
select, based on the domain, between a first candidate text embedding vector and a second candidate text embedding vector, to serve as the target text embedding vector.

20. The electronic device of claim 17, wherein
a first candidate text embedding vector among the candidate text embedding vectors is included in a first database for a first domain, and
a second candidate text embedding vector among the candidate text embedding vectors is included in a second database for a second domain.
